(19) United States
(12) Patent Application Publication
(10) Pub. No.: US 2025/0392093 A1
(43) Pub. Date: Dec. 25, 2025

(54) CLADDING LIGHT STRIPPER, METHOD FOR MANUFACTURING THE SAME, AND LASER APPARATUS

(71) Applicant: WuHan Raycus Fiber Laser Technologies CO., LTD, Wuhan, Hubei (CN)

(72) Inventors: Chunyan XU, Wuhan, Hubei (CN); Huixuan HU, Wuhan, Hubei (CN); Dapeng YAN, Wuhan, Hubei (CN); Ruirui ZHU, Wuhan, Hubei (CN); Qiurong BAO, Wuhan, Hubei (CN)

(73) Assignee: WuHan Raycus Fiber Laser Technologies CO., LTD, Wuhan, Hubei (CN)

(21) Appl. No.: 18/881,661

(22) PCT Filed: Nov. 1, 2023
(86) PCT No.: PCT/CN2023/129003

§ 371 Date: Sep. 9, 2025

(30) Foreign Application Priority Data
Dec. 8, 2022 (CN) 202211574098.2

(51) Int. Cl. H01S 3/042

(52) U.S. Cl. CPC H01S 3/042

(57) ABSTRACT

The disclosure provides a cladding light stripper, a method for manufacturing the same, and a laser apparatus. The cladding light stripper includes an optical fiber and a refractive component. A refractive index of a first refractive member of the refractive component is greater than a refractive index of the cladding layer, so as to achieve the stripping of cladding light. Moreover, cross-sectional areas of the first refractive member in a radial direction of the optical fiber gradually increase in a direction from an input end to an output end of the optical fiber, so as to avoid rapid temperature rise at local position of the first refractive element to safely strip the cladding light.

### TECHNICAL FIELD

The disclosure relates to the field of laser apparatus, and in particular, to a cladding light stripper, a method for manufacturing the same, and a laser apparatus.

### BACKGROUND

With the rapid development of high-power fiber laser apparatuses and high-power semiconductor fiber laser apparatuses, output power of the laser apparatuses is increasing continuously, and the amount of cladding light in the laser apparatuses is also increasing. Different from signal light, the cladding light belongs to stray light, the output of the cladding light not only affects the beam quality of output light, but also causes the optical fibers to heat, which may damage optical fiber devices of the laser apparatuses, and even burn the laser apparatuses. Therefore, the cladding light need to be stripped.

### SUMMARY

Embodiments of the disclosure provide a cladding light stripper, a method for manufacturing the same, and a laser apparatus, aiming to improve the problem that cladding light causes heat generation of optical fibers and damage to optical fiber devices.

Some embodiments of the disclosure provide a cladding light stripper, including:
an optical fiber including a fiber core and a cladding layer covering the fiber core; and
a refractive component including at least one first refractive member, in which the first refractive member covers at least a part of an outer peripheral surface of the cladding layer, a refractive index of the first refractive member is greater than a refractive index of the cladding layer, and cross-sectional areas of the first refractive member in a radial direction of the optical fiber gradually increase in a direction from an input end to an output end of the optical fiber.

Alternatively, thicknesses of the first refractive member in a radial direction of the fiber core gradually increase in the direction from the input end to the output end.

Alternatively, the refractive component includes a plurality of first refractive members sequentially arranged in the direction from the input end to the output end.

Alternatively, the fiber core includes a first sub-fiber core and a second sub-fiber core sequentially connected from the input end to the output end, the cladding layer includes a first sub-cladding layer and a second sub-cladding layer sequentially connected from the input end to the output end, the first sub-cladding layer covers the first sub-fiber core, and the second sub-cladding layer covers the second sub-fiber core; and the first refractive member covers at least a part of an outer peripheral surface of the first sub-cladding layer; and
the cladding light stripper further includes a reflective member covering the outer peripheral surface of the cladding layer at a connection of the first sub-cladding layer and the second sub-cladding layer, and a refractive index of the reflective member is less than the refractive index of the cladding layer.

Alternatively, the refractive component further includes at least one second refractive member covering the outer peripheral surface of the cladding layer, a refractive index of the second refractive member is greater than the refractive index of the cladding layer, and the second refractive member is disposed at a side of the reflective member in the direction from the input end to the output end.

Alternatively, cross-sectional areas of the second refractive member in the radial direction of the optical fiber gradually increase in the direction from the input end to the output end; and
the refractive component includes a plurality of second refractive members sequentially arranged in the direction from the input end to the output end.

Alternatively, the optical fiber further includes a first coating layer and a second coating layer covering the cladding layer, the first coating layer and the second coating layer are sequentially arranged at intervals in the direction from the input end to the output end, and the refractive component is disposed between the first coating layer and the second coating layer; and
a ratio of a length of the refractive component in an extension direction of the optical fiber to a distance between the first coating layer and the second coating layer is greater than or equal to 90%; and a ratio of a total length of the first refractive member in the extension direction of the optical fiber to the distance between the first coating layer and the second coating layer is greater than or equal to 46%.

Some embodiments of the disclosure provide a method for manufacturing a cladding light stripper, including the steps of:
providing an optical fiber, in which the optical fiber includes a fiber core and a cladding layer covering the fiber core; and
disposing at least one first refractive member on an outer peripheral surface of the cladding layer, in which the first refractive member covers at least a part of the outer peripheral surface of the cladding layer, a refractive index of the first refractive member is greater than a refractive index of the cladding layer, and cross-sectional areas of the first refractive member in a radial direction of the optical fiber gradually increase in a direction from an input end to an output end of the optical fiber.

Alternatively, a step of disposing at least one first refractive member on an outer peripheral surface of the cladding layer includes the steps of:
applying a refractive glue on the outer peripheral surface of the cladding layer, in which a refractive index of the refractive glue is greater than the refractive index of the cladding layer; and
stretching the refractive glue in the direction from the output end to the input end of the optical fiber by using a stretching member to form the first refractive member.

Alternatively, the first refractive member is plural, and a plurality of first refractive members are sequentially arranged in the direction from the input end to the output end.

Alternatively, the fiber core includes a first sub-fiber core and a second sub-fiber core sequentially connected from the input end to the output end, the cladding layer includes a first sub-cladding layer and a second sub-cladding layer sequentially connected from the input end to the output end, the first sub-cladding layer covers the first sub-fiber core, and the second sub-cladding layer covers the second sub-fiber core; and the first refractive member covers at least a part of an outer peripheral surface of the first sub-cladding layer; and in which the method further includes the step of:
disposing a reflective member on an outer peripheral surface at a connection of the first sub-cladding layer and the second sub-cladding layer, in which the reflective member covers the cladding layer, and a refractive index of the reflective member is less than the refractive index of the cladding layer.

Alternatively, the method further includes: disposing a second refractive member covering the outer peripheral surface of the cladding layer at a side of the reflective member in the direction from the input end to the output end, in which a refractive index of the second refractive member is greater than the refractive index of the cladding layer.

Alternatively, cross-sectional areas of the second refractive member in the radial direction of the optical fiber gradually increase in the direction from the input end to the output end; or, cross-sectional areas of the second refractive member in the radial direction of the optical fiber remain constant in the direction from the input end to the output end.

Some embodiments of the disclosure further provide a laser apparatus including a cladding light stripper, and the cladding light stripper includes:
an optical fiber including a fiber core and a cladding layer covering the fiber core; and
a refractive component including at least one first refractive member, in which the first refractive member covers at least a part of an outer peripheral surface of the cladding layer, a refractive index of the first refractive member is greater than a refractive index of the cladding layer, and cross-sectional areas of the first refractive member in a radial direction of the optical fiber gradually increase in a direction from an input end to an output end of the optical fiber.

Alternatively, thicknesses of the first refractive member in a radial direction of the fiber core gradually increase in the direction from the input end to the output end.

Alternatively, the refractive component includes a plurality of first refractive members sequentially arranged in the direction from the input end to the output end.

Alternatively, the fiber core includes a first sub-fiber core and a second sub-fiber core sequentially connected from the input end to the output end, the cladding layer includes a first sub-cladding layer and a second sub-cladding layer sequentially connected from the input end to the output end, the first sub-cladding layer covers the first sub-fiber core, and the second sub-cladding layer covers the second sub-fiber core; and the first refractive member covers at least a part of an outer peripheral surface of the first sub-cladding layer; and
the cladding light stripper further includes a reflective member covering the outer peripheral surface of the cladding layer at a connection of the first sub-cladding layer and the second sub-cladding layer, and a refractive index of the reflective member is less than the refractive index of the cladding layer.

Alternatively, the refractive component further includes at least one second refractive member covering the outer peripheral surface of the cladding layer, a refractive index of the second refractive member is greater than the refractive index of the cladding layer, and the second refractive member is disposed at a side of the reflective member in the direction from the input end to the output end.

Alternatively, cross-sectional areas of the second refractive member in the radial direction of the optical fiber gradually increase in the direction from the input end to the output end; and
the refractive component includes a plurality of second refractive members sequentially arranged in the direction from the input end to the output end.

Alternatively, the optical fiber further includes a first coating layer and a second coating layer covering the cladding layer, the first coating layer and the second coating layer are sequentially arranged at intervals in the direction from the input end to the output end, and the refractive component is disposed between the first coating layer and the second coating layer; and
a ratio of a length of the refractive component in an extension direction of the optical fiber to a distance between the first coating layer and the second coating layer is greater than or equal to 90%; and a ratio of a total length of the first refractive member in the extension direction of the optical fiber to the distance between the first coating layer and the second coating layer is greater than or equal to 46%. Any one of cladding light strippers as described above.

### Beneficial Effects

In the cladding light stripper provided in the embodiments of the disclosure, by providing the refractive component on the outer peripheral surface of the cladding layer, and the first refractive member having the refractive index greater than the refractive index of the cladding layer, when cladding light in the cladding layer and the optical fiber is transmitted to the position where the cladding layer and the first refractive member are connected in the direction from the input end to the output end of the optical fiber, the refractive index suddenly changes due to different refractive indices of the cladding layer and the first refractive member, and thus, the cladding light may be refracted to the first refractive member and then scattered to external of the optical fiber through the first refractive member, thereby achieving the stripping of the cladding light. Moreover, by providing the cross-sectional areas of the first refractive member in the radial direction of the optical fiber gradually increasing in the direction from the input end to the output end of the optical fiber, a stepped heat dissipation can be achieved in the direction from the input end to the output end of the optical fiber, so as to avoid a rapid temperature rise at local position of the first refractive member, and safely strip the cladding light.

### BRIEF DESCRIPTION OF THE DRAWINGS

In order to explain technical solutions in embodiments of the disclosure more clearly, the following will briefly introduce the drawings needed to be used in description of the embodiments. Apparently, the drawings in the following description are only some embodiments of the disclosure. For ordinary skilled in the art, other drawings can be obtained from these drawings without paying creative effort.

FIG. 1 is a first schematic cross-sectional diagram of a cladding light stripper in an axial direction of an optical fiber provided in some embodiments of the disclosure;

FIG. 2 is a second schematic cross-sectional diagram of the cladding light stripper in the axial direction of the optical fiber provided in some embodiments of the disclosure;

FIG. 3 is a third schematic cross-sectional diagram of the cladding light stripper in the axial direction of the optical fiber provided in some embodiments of the disclosure; and

FIG. 4 is a schematic flowchart of a method for manufacturing a cladding light stripper provided in some embodiments of the disclosure.

### REFERENCE CHARACTERS

1000/1000a/1000b, cladding light stripper; 1100/1100a, optical fiber; 1101/1101a/1101b, input end; 1102/1102a/1102b, output end; 1110, fiber core; 1111, first sub-fiber core; 1112, second sub-fiber core; 1120/1120/1120b, cladding layer; 1121, first sub-cladding layer; 1122, second sub-cladding layer; 1130, first coating layer; 1140, second coating layer; 1200/1200a/1200b, refractive component; 1210/1210a/1210b, first refractive member; 1220, second refractive member; 1300, reflective member; and 100a/100b, optical fiber coating layer.

### DETAILED DESCRIPTION

The following will provide a clear and complete description of the technical solutions in the embodiments of the disclosure, in conjunction with the drawings. Apparently, the described embodiments are only a part of the embodiments of the disclosure, not all of them. Based on the embodiments of the disclosure, all other embodiments obtained by those skilled in the art without creative labor are within the scope of protection of the disclosure. Furthermore, it can be understood that the detailed description described herein is for illustration and explanation of the disclosure, and is not intended to limit the disclosure. In the disclosure, unless otherwise specified, the directional terms, such as “up” and “down”, generally refer to upward and downward directions of the device in the actual use or working state, specifically the directions in the drawings; and the terms “inside” and “outside” are relative to the contour of the devices shown in the drawings.

Embodiments of the disclosure provide a cladding light stripper, a method for manufacturing the same, and a laser apparatus, which will be described in detail in the following.

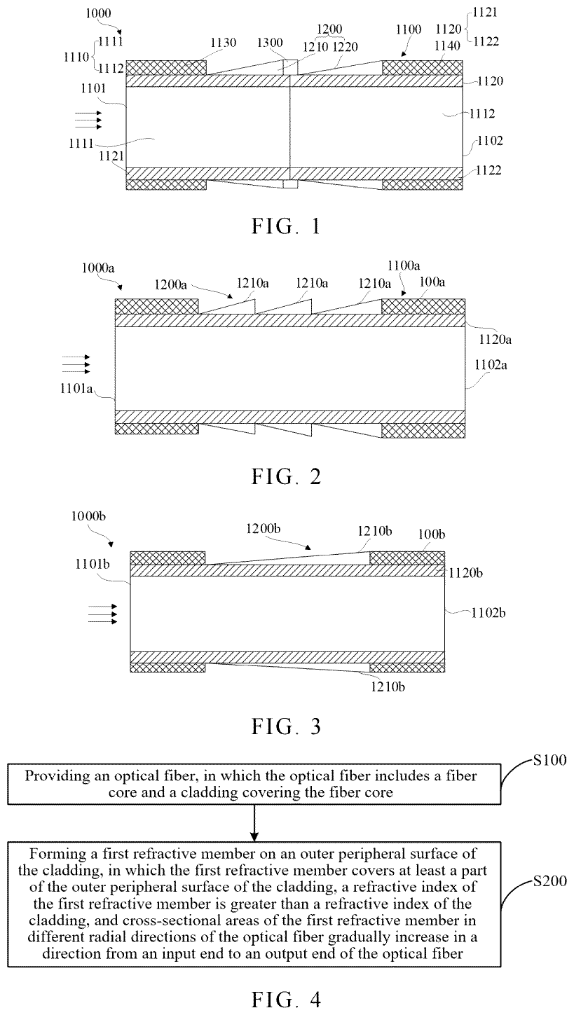

FIG. 1 is a first schematic cross-sectional diagram of a cladding light stripper in an axial direction of an optical fiber provided in some embodiments of the disclosure. As illustrated in FIG. 1, some embodiments of the disclosure provide a cladding light stripper 1000 for safely stripping cladding light, avoiding damage to optical devices caused by temperature rise during the stripping of the cladding light. The cladding light stripper 1000 includes an optical fiber 1100 for transmitting light. The optical fiber 1100 includes a fiber core 1110 and a cladding layer 1120 covering the fiber core 1110. A refractive index of the cladding layer 1120 is less than a refractive index of the fiber core 1110, so that signal light is enclosed in the fiber core 1110 and propagated. However, there may be stray light entering the cladding layer 1120 to form cladding light during the operation.

The cladding light stripper 1000 further includes a refractive component 1200, and the refractive component 1200 includes at least one first refractive member 1210. A refractive index of the first refractive member 1210 is greater than the refractive index of the cladding layer 1120. The first refractive member 1210 covers at least a part of an outer peripheral surface of the cladding layer 1120. Cross-sectional areas of the first refractive member 1210 in a radial direction of the optical fiber 1100 gradually increase in a direction from an input end 1101 to an output end 1102 of the optical fiber 1100. The input end 1101 of the optical fiber 1100 is configured to receive light, and the output end 1102 of the optical fiber 1100 is configured to output light.

In the embodiments of the disclosure, by providing the first refractive member 1210 on the outer peripheral surface of the cladding layer 1120 and having the refractive index greater than the refractive index of the cladding layer 1120, when cladding light in the cladding layer 1120 and the optical fiber 1100 is transmitted to the position where the cladding layer 1120 and the first refractive member 1210 are connected in the direction from the input end 1101 to the output end 1102 of the optical fiber 1100, the refractive index suddenly changes due to different refractive indices of the cladding layer 1120 and the first refractive member 1210, and thus, the cladding light may be refracted to the first refractive member 1210 and then scattered to external of the optical fiber 1100 through the first refractive member 1210, thereby achieving the stripping of the cladding light.

Moreover, by providing the cross-sectional areas of the first refractive member 1210 in the radial direction of the optical fiber 1100 gradually increasing in the direction from the input end 1101 to the output end 1102 of the optical fiber 1100, when cladding light enters the first refractive member 1210, due to the sudden change in refractive index, a region where the cladding light is intensively stripped may be the region where the cross-sectional areas of the optical fiber 1100 in the radial direction are smaller. Moreover, when stripping the cladding light, the region where the cross-sectional areas of the optical fiber 1100 in the radial direction are smaller has a highest temperature. Furthermore, since the region where the cross-sectional areas of the optical fiber 1100 in the radial direction are smaller, heat generated during the stripping of the cladding light may be easily dissipated to external, and then transferred to next region of the first refractive member 1210 adjacent to the above region. The cross-sectional areas of the first refractive member 1210 in the radial direction of the optical fiber 1100 in the next region are larger, so that heat in the next region is quickly dissipated, thereby achieving a stepped heat dissipation.

The temperature of the first refractive member 1210 may gradually decrease in the direction from the input end 1101 to the output end 1102, so that the first refractive member 1210 can continuously dissipate heat according to the principle of heat conduction. Moreover, both of a part of the first refractive member 1210 and a part of the cladding layer 1120 that are in contact with each other are configured to strip cladding light. Since the cladding light is stray light, by providing the first refractive member 1210 covering the outer peripheral surface of the cladding layer 1120, the cladding light can be stripped in a circumferential direction of the cladding layer 1120, making the stripping of the cladding light more complete and achieving the heat dissipation in the circumferential direction.

In some embodiments, the first refractive member 1210 covers the cladding layer 1120 in the circumferential direction of the cladding layer 1120. The first refractive member 1210 covers at least a part of an outer circumferential surface of the cladding layer 1120 in an extension direction of the optical fiber 1100; alternatively, the first refractive member 1210 covers the entirety of the outer circumferential surface of the cladding layer 1120 in the extension direction of the optical fiber 1100.

In some embodiments, the refractive component 1200 includes one first refractive member 1210.

Alternatively, in some embodiments, the fiber core 1110 includes a first sub-fiber core 1111 and a second sub-fiber core 1112 sequentially connected from the input end 1101 to the output end 1102, and the cladding layer 1120 includes a first sub-cladding layer 1121 and a second sub-cladding layer 1122 sequentially connected from the input end 1101 to the output end 1102. The first sub-cladding layer 1121 covers the first sub-fiber core 1111, and the second sub-cladding layer 1122 covers the second sub-fiber core 1112. The first refractive member 1210 covers at least a part of an outer peripheral surface of the first sub-cladding layer 1121.

In some embodiments, two segments of optical fibers 1100 having the same specifications are connected to each other. The first refractive member 1210 covers at least a part of the outer peripheral surface of the first sub-cladding layer 1121 in the direction from the input end 1101 to the output end 1102, so that cladding light can be stripped by the first refractive member 1210 on the first sub-cladding layer 1121, and cladding light that does not enter the second sub-cladding layer 1122 can be stripped as well.

In some embodiments, the first refractive member 1210 covers a part of the outer peripheral surface of the first sub-cladding layer 1121; alternatively, the first refractive member 1210 covers the entirety of the outer peripheral surface of the first sub-cladding layer 1121. Moreover, two segments of optical fibers 1100 are connected by welding; alternatively, two segments of optical fibers 1100 are connected through an optical fiber connector.

Before two segments of optical fibers 1100 are welded, a coating layer of each of the two segments of optical fibers 1100 at the connection of the two segments of optical fibers 1100 is removed. Moreover, when the two segments of optical fibers 1100 are connected by an optical fiber connector, the optical fiber connector includes a single-mode connector.

Alternatively, in some embodiments, the cladding light stripper 1000 further includes a reflective member 1300, the reflective member 1300 covers an outer peripheral surface of the cladding layer 1120 at the connection of the first sub-cladding layer 1121 and the second sub-cladding layer 1122, and a refractive index of the reflective member 1300 is less than the refractive index of the cladding layer 1120. In the embodiments, by providing the reflective member 1300 covering the outer peripheral surface of the cladding layer 1120 at the connection of the first sub-cladding layer 1121 and the second sub-cladding layer 1122, the reflective member 1300 may be in direct contact with the first sub-cladding layer 1121 and the second sub-cladding layer 1122. Moreover, the refractive index of the reflective member 1300 is less than a refractive index of the first sub-cladding layer 1121 and a refractive index of the second sub-cladding layer 1122, so that cladding light in the first sub-cladding layer 1121 and the second sub-cladding layer 1122 can reflect on the reflective member 1300, avoiding leakage of the cladding light at the connection of the two segments of optical fibers 1100, which may lead to higher temperature at local position of the optical fiber 1100 and damage to optical devices.

In some embodiments, the reflective member 1300 covers the cladding layer 1120 in a circumferential direction of the cladding layer 1120, and the reflective member 1300 covers the cladding layer 1120 at the connection of the first sub-cladding layer 1121 and the second sub-cladding layer 1122 in the extension direction of the optical fiber 1100. Furthermore, the reflective member 1300 and the first refractive member 1210 are disposed at intervals or directly connected to each other.

In some embodiments, the reflective member 1300 is formed by curing a reflective glue. During the process for preparing the reflective member 1300, the reflective glue is applied at the connection of the first sub-cladding layer 1121 and the second sub-cladding layer 1122 along the extension direction of the optical fiber 1100, and then the reflective glue is cured to form the reflective member 1300. For example, the method for applying the reflective glue includes a dispensing process, a coating process, or the like. Moreover, a refractive index of the reflective glue is less than the refractive index of the first sub-cladding layer 1121 and the refractive index of the second sub-cladding layer 1122, so that the reflective glue can reflect cladding light. In some embodiments, when two segments of optical fibers 1100 having the same specifications are connected to each other by welding, the reflective glue is applied onto the connection of the first sub-cladding layer 1121 and the second sub-cladding layer 1122, so as to avoid light leakage at the welding position of the two segments of optical fibers, which may cause damage to optical devices due to temperature rise at the welding position.

In some embodiments, in order to effectively reflect light at the connection of the first sub-cladding layer 1121 and the second sub-cladding layer 1122 and save cost of the reflective member 1300, a length of the reflective member 1300 in the extension direction of the optical fiber 1100 ranges between 0.3 cm and 0.5 cm. When the reflective member 1300 is formed by the dispensing process, the glue is applied at the connection of the first sub-cladding layer 1121 and the second sub-cladding layer 1122 and naturally cured, so as to form the reflective member 1300 having the length of 0.3 cm to 0.5 cm. This process is simple and achieves a good reflection effect on cladding light.

Alternatively, in some embodiments, the refractive component 1200 further includes at least one second refractive member 1220, and a refractive index of the second refractive member 1220 is greater than the refractive index of the cladding layer 1120. The second refractive member 1220 covers an outer peripheral surface of the cladding layer 1120, and the second refractive member 1220 is disposed at a side of the reflective member 1300 in the direction from the input end 1101 to the output end 1102. In the embodiments, by providing the second refractive member 1220 at a side of the reflective member 1300 in the direction from the input end 1101 to the output end 1102, it can be achieved that the second refractive member 1220 strips cladding light transmitted from the reflective member 1300, and the first refractive member 1210 and the second refractive member 1220 cooperate with each other to strip more cladding light. Furthermore, the first refractive member 1210, the reflective member 1300, and the second refractive member 1220 can cooperate with each other to strip cladding light in the two segments of optical fibers 1100 that are connected to each other.

In the disclosure, the second refractive member 1220 and the reflective member 1300 are disposed at intervals or directly connected to each other. Moreover, the number of the second refractive members 1220 is one or a plurality.

In some embodiments, the second refractive member 1220 and the reflective member 1300 are disposed at intervals, and the second refractive member 1220 covers a part of the second sub-cladding layer 1122. In some embodiments, the second refractive member 1220 and the reflective member 1300 are directly connected to each other, and the second refractive member 1220 is configured to strip cladding light that is not stripped by the first refractive member 1210.

In some embodiments, in the direction from the input end 1101 to the output end 1102, cross-sectional areas of the second refractive member 1220 in the radial direction of the optical fiber 1100 are close to a constant value. For example, thicknesses of the second refractive member 1220 in a radial direction of the fiber core 1110 are close to a constant value.

Alternatively, in some embodiments, the cross-sectional areas of the second refractive member 1220 in the radial direction of the optical fiber 1100 gradually increase in the direction from the input end 1101 to the output end 1102. In the embodiments, by providing the cross-sectional areas of the second refractive member 1220 in the radial direction of the optical fiber 1100 gradually increasing in the direction from the input end 1101 to the output end 1102, during the refraction of cladding light that is transmitted from the reflective element 1300, heat generated due to the sudden change in refractive index can be gradually transferred to external, avoiding damage to optical devices caused by temperature rise.

In some embodiments, thicknesses of the second refractive member 1220 in the radial direction of the optical fiber 1100 gradually increase in the direction from the input end 1101 to the output end 1102.

In the disclosure, the thicknesses of the second refractive member 1220 in the radial direction of the optical fiber 1100 gradually increase by the same amplitude or different amplitudes.

In some embodiments, the thicknesses of the second refractive member 1220 in the radial direction of the optical fiber 1100 gradually increase by the same amplitude, and an outer peripheral surface of the second refractive member 1220 is a conical surface, a pyramidal surface, or the like. In some embodiments, the thicknesses of the second refractive member 1220 in the radial direction of the optical fiber 1100 gradually increase with different amplitudes, and the outer peripheral surface of the second refractive member 1220 is a paraboloid surface, for example, an elliptical paraboloid surface.

In some embodiments, in the direction from the input end 1101 to the output end 1102, the cross-sectional areas of the second refractive member 1220 in the radial direction of the optical fiber 1100 gradually increase, thicknesses of one end of the second refractive member 1220 suddenly increase, and thicknesses of another end of the second refractive member 1220 gradually decrease. In the embodiments, one end of the second refractive member 1220 with the suddenly increased thicknesses may lead to a general heat dissipation effect, and another end of the second refractive member 1220 with the gradually decreased thicknesses may have a better heat dissipation effect.

Alternatively, in some embodiments, the refractive component 1200 includes a plurality of second refractive members 1220 sequentially arranged in the direction from the input end 1101 to the output end 1102. In the embodiments, the plurality of second refractive members 1220 can strip cladding light and dissipate heat generated in the process of stripping the cladding light.

In the disclosure, the plurality of second refractive members 1220 are connected to each other; alternatively, several second refractive members 1220 among the plurality of second refractive members 1220 are connected to each other, and remaining second refractive members 1220 among the plurality of second refractive members 1220 are disposed at intervals; and alternatively, the plurality of second refractive members 1220 are disposed at intervals.

In some embodiments, the plurality of second refractive members 1220 are connected to each other, so that every two adjacent second refractive members 1220 can cooperate with each other to achieve heat dissipation, and the plurality of second refractive members 1220 are connected to each other to strip more cladding light.

In some embodiments, several second refractive members 1220 among the plurality of second refractive members 1220 are connected to each other, and remaining second refractive members 1220 among the plurality of second refractive members 1220 are disposed at intervals.

In some embodiments, the plurality of second refractive members 1220 are disposed at intervals. For example, the plurality of second refractive members 1220 are disposed at equal intervals. Furthermore, more cladding light may be stripped by increasing the number of the second refractive members 1220.

Alternatively, in some embodiments, the optical fiber 1100 includes a first coating layer 1130 and a second coating layer 1140 covering the cladding layer 1120, and the first coating layer 1130 and the second coating layer 1140 are sequentially arranged at intervals in the direction from the input end 1101 to the output end 1102. The refractive component 1200 is disposed between the first coating layer 1130 and the second coating layer 1140. In the embodiments, by providing the refractive component 1200 on the cladding layer 1120 between the first coating layer 1130 and the second coating layer 1140, the stripping of cladding light in the two segments of optical fibers 1100 can be achieved.

In order to achieve a better stripping effect on cladding light and a better heat dissipation effect, a distance between the first coating layer 1130 and the second coating layer 1140 can be adjusted.

For example, for optical fibers with the specifications of 135/155 μm, the distance between the first coating layer 1130 and the second coating layer 1140 range between 4.6 cm and 5 cm. It can be understood that, there may be a difference in the distance between the first coating layer 1130 and the second coating layer 1140 when using two optical fibers with different specifications.

In some embodiments, both of the refractive component 1200 and the reflective member 1300 are disposed between the first coating layer 1130 and the second coating layer 1140. The reflective member 1300 is disposed at the connection of the first sub-cladding layer 1121 and the second sub-cladding layer 1122, and the refractive component 1200 is disposed at one side or two sides of the reflective member 1300 in the extension direction of the optical fiber 1100.

Alternatively, in some embodiments, a ratio of a length of the refractive component 1200 in the extension direction of the optical fiber 1100 to the distance between the first coating layer 1130 and the second coating layer 1140 is greater than or equal to 90%, and a ratio of a total length of the first refractive members 1210 in the extension direction of the optical fiber 1100 to the distance between the first coating layer 1130 and the second coating layer 1140 is greater than or equal to 46%. In the reconnected two segments of optical fibers 1100 provided in the embodiments, by controlling the smallest ratio of the refractive component 1200 covering the cladding layer 1120, a better heat dissipation effect and a better stripping effect on the cladding light can be achieved. Moreover, by controlling the ratio of the first refractive member 1210 covering the cladding layer 1120, the first refractive member 1210 and the second refractive member 1220 can cooperate with each other to achieve the stripping of the cladding light in the reconnected two segments of optical fibers 1100, and achieve heat dissipation during the stripping of the cladding light.

In the embodiments, by adjusting the ratio of the length of the first refractive member 1210 in the extension direction of the optical fiber 1100 to the distance between the first coating layer 1130 and the second coating layer 1140, a ratio of a length of the second refractive member 1220 in the extension direction of the optical fiber 1100 and the distance between the first coating layer 1130 and the second coating layer 1140 can be obtained accordingly.

In some embodiments, the number of the first refractive members 1210 is one, and the ratio of the length of the first refractive members 1210 in the extension direction of the optical fiber 1100 to the distance between the first coating layer 1130 and the second coating layer 1140 is greater than or equal to 46%. For example, the number of the first refractive member 1210 is a plurality, and a ratio of lengths of a plurality of first refractive members 1210 in the extension direction of the optical fiber 1100 to the distance between the first coating layer 1130 and the second coating layer 1140 is greater than or equal to 46%.

Alternatively, in some embodiments, thicknesses of the first refractive member 1210 in the radial direction of the fiber core 1110 gradually increase in the direction from the input end 1101 to the output end 1102. In the embodiments, the thicknesses of the first refractive member 1210 in the radial direction of the fiber core 1110 gradually increase in the direction from the input end 1101 to the output end 1102, so that thicknesses of the first refractive member 1210 in the circumferential direction gradually increase in the direction from the input end 1101 to the output end 1102, improving the heat transfer efficiency, enabling the first refractive member 1210 to stably and uniformly dissipate heat to external, avoiding the phenomena that heat dissipation too fast and heat dissipation too slow simultaneously occurs in the circumferential direction of the first refractive member 1210, and improving the heat dissipation efficiency.

In the disclosure, the thicknesses of the first refractive member 1210 in the radial direction of the optical fiber 1100 gradually increase by the same amplitude or different amplitudes.

In some embodiments, the thicknesses of the first refractive member 1210 in the radial direction of the optical fiber 1100 gradually increase by the same amplitude, and the outer peripheral surface of the first refractive member 1210 is a conical surface, a pyramidal surface, or the like. In some embodiments, the thicknesses of the first refractive member 1210 in the radial direction of the optical fiber 1100 gradually increase with different amplitudes, and the outer peripheral surface of the first refractive member 1210 is a paraboloid surface, for example, an elliptical paraboloid surface.

In some embodiments, the cross-sectional areas of the first refractive member 1210 in the radial direction of the optical fiber 1100 gradually increase, thicknesses of one end of the first refractive member 1210 suddenly increase, and thicknesses of another end of the first refractive member 1210 gradually decrease. In the embodiments, one end of the first refractive member 1210 with the suddenly increased thicknesses may lead to a general heat dissipation effect, and another end of the first refractive member 1210 with the gradually decreased thicknesses may have a better heat dissipation effect. Therefore, the first refractive member 1210 provided in the embodiments can achieve a heat dissipation effect as a whole.

FIG. 2 is a second schematic cross-sectional diagram of a cladding light stripper in an axial direction of an optical fiber provided in some embodiments of the disclosure. As illustrated in FIG. 2, in some embodiments, a refractive component 1200a of a cladding light stripper 1000a includes a plurality of first refractive members 1210a, and the plurality of first refractive members 1210a are sequentially arranged in a direction from an input end 1101a to an output end 1102a. In the embodiments, the plurality of first refractive members 1210a can strip cladding light and dissipate heat generated due to a sudden change in the refractive index of the medium during the refraction process of the cladding light.

In some embodiments, the plurality of first refractive members 1210a are connected to each other. Alternatively, some of the first refractive members 1210a among the plurality of first refractive members 1210a are connected to each other, and remaining first refractive members 1210a among the plurality of first refractive members 1210a are disposed at intervals. Alternatively, any two of the plurality of first refractive members 1210a are disposed at intervals.

For example, some of the first refractive members 1210a among the plurality of first refractive members 1210a are connected to each other, and remaining first refractive members 1210a among the plurality of first refractive members 1210a are disposed at intervals. Among the first refractive members 1210a that are disposed at intervals, the first refractive members 1210a that contact with a cladding layer 1120a may strip a large amount of cladding light due to a sudden change in refractive index, causing the rising of temperature at the contact position. Moreover, the first refractive members 1210a that are connected to each other may continuously strip the cladding light in the cladding layer 1120a in the direction from the input end 1101a to the output end 1102a. At this time, the temperature at the position where the first refractive members 1210a contact with the cladding layer 1120a rises and is in a range of a predetermined operation temperature, in which the cladding light stripper 1000a can safely strip the cladding light. In some embodiments, the first refractive members 1210a are connected to an optical fiber coating layer 100a covering the cladding layer 1120a; alternatively, the first refractive members 1210a and the optical fiber coating layer 100a are disposed at intervals.

In some embodiments, the plurality of first refractive members 1210a are disposed at intervals from each other. Furthermore, a distance between two adjacent first refractive members 1210a may be controlled to avoid a large amount of accumulation of cladding light in the cladding layer 1120a. In some embodiments, the plurality of first refractive members 1210a are disposed at equal intervals; alternatively, the plurality of first refractive members 1210a are disposed at unequal intervals.

Alternatively, in some embodiments, the refractive component 1200a includes the plurality of first refractive members 1210a that are sequentially connected in the direction from the input end 1101a to the output end 1102a. In the embodiments, the plurality of first refractive members 1210a are provided to be connected end-to-end, that is, a part of each first refractive member 1210a having a larger cross-sectional area in the radial direction of the optical fiber 1100a is connected to adjacent one first refractive member 1210a having a smaller cross-sectional area in the radial direction of the optical fiber 1100a. Since the part of the first refractive member 1210a having a larger cross-sectional area in the radial direction of the optical fiber 1100a has a slower heat dissipation rate, and the part of the first refractive member 1210a having a smaller cross-sectional area in the radial direction of the optical fiber 1100a has a faster heat dissipation rate, heat in the part of the first refractive member 1210a having the larger cross-sectional area in the radial direction of the optical fiber 1100a can be transferred to the part of the first refractive member 1210a having the smaller cross-sectional area through the cladding layer 1120, thereby avoiding the local temperature rise caused by accumulation of heat.

Moreover, contact parts of two adjacent first refractive members 1210a may conduct heat synchronously, avoiding the accumulation of heat in the first refractive members 1210a, and achieving the operation of the cladding light stripper 1000a for a long period of time without a cooling device.

When the plurality of first refractive members 1210a are provided, in order to achieve a better heat dissipation effect, a length of each first refractive member 1210a in an extension direction of the optical fiber 1100a can be controlled to fully strip the cladding light, thereby achieving a better heat dissipation effect.

For example, for optical fibers with the specifications of 135/155 μm, the length of each first refractive member 1210a in the extension direction of the optical fiber 1100a is greater than or equal to 2.3 cm, so that the first refractive members 1210a can fully strip the cladding light, achieving a better heat dissipation effect of the first refractive members 1210a in the extension direction of the optical fiber 1100a.

FIG. 3 is a third schematic cross-sectional diagram of a cladding light stripper in an axial direction of an optical fiber provided in some embodiments of the disclosure. As illustrated in FIG. 3, in some embodiments, a refractive component 1200b omits the reflective member 1300 and the second refractive member 1220, and the refractive component 1200b includes one first refractive member 1210b. In the embodiments, the first refractive member 1210b covers the entirety of a cladding layer 1120b; alternatively, the first refractive member 1210b covers at least a part of an outer peripheral surface of the cladding layer 1120b in a direction from an input end 1101b to an output end 1102b.

As illustrated in FIG. 3, during the actual operation processes, an optical fiber coating layer 100b may be removed to expose the cladding layer 1120b, and then the refractive component 1200b is disposed on the cladding layer 1120b to form a cladding light stripper 1000b.

Some embodiments of the disclosure further provide a method for manufacturing a cladding light stripper, which can be used to manufacture the cladding light stripper 1000 as described above. The structure of the cladding light stripper 1000 can refer to the above embodiments. Since the cladding light stripper 1000 manufactured by the method adopts all the technical solutions of all the above embodiments, it has at least all the beneficial effects brought by the technical solutions of the above embodiments, and will not be repeated here. FIG. 4 is a schematic flowchart of a method for manufacturing a cladding light stripper provided in some embodiments of the disclosure.

As illustrated in FIG. 4, a method for manufacturing a cladding light stripper includes the following steps:
Step S100, providing an optical fiber, in which the optical fiber includes a fiber core and a cladding layer covering the fiber core; and
Step S200, disposing at least one first refractive member on an outer peripheral surface of the cladding layer, in which the first refractive member covers at least a part of the outer peripheral surface of the cladding layer, a refractive index of the first refractive member is greater than a refractive index of the cladding layer, and cross-sectional areas of the first refractive member in a radial direction of the optical fiber gradually increase in a direction from an input end to an output end of the optical fiber.

By using the above method, cladding light in the optical fiber 1100 can be safely stripped, excessive temperature rise caused by the stripping of the cladding light can be avoided, and damage to optical devices can be avoided.

In some embodiments, the first refractive member 1210 is formed by the stretching of a refractive glue; alternatively, the first refractive member 1210 is formed by a mold. For example, polytetrafluoroethylene is coated on an inner wall of a mold to form a coating layer, and then the coating layer demolds to form as the first refractive member 1210.

In some embodiments, the refractive glue is cured and formed, and a refractive index of the refractive glue is greater than the refractive index of the cladding layer 1120. Furthermore, the cladding layer 1120 covering the fiber core 1110 is wrapped in a hollow mold, and then the refractive glue is injected into the mold and formed in the mold to form the first refractive member 1210 that has cross-sectional areas gradually increasing in the radial direction of the optical fiber 1100. It can be understood that cross-sectional areas of an inner cavity of the mold gradually increase in the radial direction of the optical fiber 1100.

Alternatively, in some embodiments, the step of disposing at least one first refractive member on the outer peripheral surface of the cladding layer includes the steps of:
applying the refractive glue on the outer peripheral surface of the cladding layer, in which the refractive index of the refractive glue is greater than the refractive index of the cladding layer; and
stretching the refractive glue along the direction from the output end to the input end of the optical fiber by using a stretching member to form the first refractive member.

By applying the refractive glue and then stretching the refractive glue, cross-sectional areas of the refractive glue in the radial direction of the optical fiber 1100 gradually increase in the direction from the input end 1101 to the output end 1102 of the optical fiber 1100. This method is simple and feasible, effectively stripping cladding light, and avoiding the damage to the optical devices due to excessive temperature rise caused by the stripping of the cladding light.

The step of applying the refractive glue on the outer circumferential surface of the cladding layer 1120 includes the step of: dropping the refractive glue along the circumferential direction of the cladding layer 1120, or coating the refractive glue along the circumferential direction of the cladding layer 1120. Methods of applying the refractive glue include, but not limited to the above methods.

After refractive glue droplets contact with the cladding layer 1120, the refractive glue and the cladding layer 1120 are bonded together. Since the initial refractive glue needs to be stretched, the amount of the refractive glue applied can be controlled according to a stretching length of the refractive glue. When the stretching length of the refractive glue is longer, the amount of the refractive glue applied may be larger; and when the stretching length of the refractive glue is shorter, the amount of the refractive glue applied may be smaller.

In some embodiments, a mold is used to form the first refractive member 1210 having thicknesses in the radial direction of the fiber core 1110 gradually increasing in the direction from the input end 1101 to the output end 1102.

In some embodiments, by applying and stretching the refractive glue for many times along the direction from the output end 1102 to the input end 1101 of the optical fiber 1100, a plurality of first refractive members 1210 sequentially arranged in the direction from the input end 1101 to the output end 1102 can be formed.

In an optical device, when connecting different components, two segments of optical fibers 1100 are generally connected to each other. Before connecting two segments of optical fibers 1100, a coating layer on each of the two segments of optical fibers 1100 at the position where the two segments of optical fibers 1100 are prepared to be connected is stripped, and then the two segments of optical fibers 1100 are connected to form one segment of optical fiber 1100. The optical fiber 1100 includes the first sub-fiber core 1111 and the second sub-fiber core 1112 sequentially connected in the direction from the input end 1101 to the output end 1102. The cladding layer 1120 includes the first sub-cladding layer 1122 and the second sub-fiber core 1112 sequentially connected in the direction from the input end 1101 to the output end 1102. The first sub-cladding layer 1121 covers the first sub-fiber core 1111, and the first sub-cladding layer 1122 covers the second sub-fiber core 1112. The first refractive member 1210 covers at least a part of an outer peripheral surface of the first sub-cladding layer 1121.

Thereafter, the reflective member 1300 is formed on the outer peripheral surface at the connection of the first sub-cladding layer 1121 and the second sub-cladding layer 1122. The reflective member 1300 covers the cladding layer 1120, and the refractive index of the reflective member 1300 is less than the refractive index of the cladding layer 1120.

In some embodiments, the reflective member 1300 is made from a reflective glue, and a refractive index of the reflective glue is less than the refractive index of the cladding layer 1120.

For example, the reflective member 1300 is formed by applying the reflective glue on the outer circumferential surface at the connection of the first sub-cladding layer 1121 and the second sub-cladding layer 1122 along the circumferential direction. The first refractive member 1210 covers at least a part of an outer peripheral surface of the first sub-cladding layer 1121 in the direction from the input end 1101 to the output end 1102.

In some embodiments, the second refractive member 1220 covering the outer peripheral surface of the cladding layer 1120 is formed at a side of the reflective member 1300 in the direction from the input end 1101 to the output end 1102, and the refractive index of the second refractive member 1220 is greater than the refractive index of the cladding layer 1120.

In some embodiments, the cross-sectional areas of the second refractive member 1220 in the radial direction of the optical fiber 1100 gradually increase in the direction from the input end 1101 to the output end 1102; alternatively, the cross-sectional areas of the second refractive member 1220 in the radial direction of the optical fiber 1100 remain constant in the direction from the input end 1101 to the output end 1102.

When the cross-sectional areas of the second refractive member 1220 in the radial direction of the optical fiber 1100 gradually increase in the direction from the input end 1101 to the output end 1102, the method for forming the second refractive member 1220 is the same as the method for forming the first refractive member 1210, and will not be repeated herein. When the cross-sectional areas of the second refractive member 1220 in the radial direction of the optical fiber 1100 remain constant in the direction from the input end 1101 to the output end 1102, the second refractive member 1220 is formed by a mold.

The number of the second refractive member 1220 is one or a plurality. When the number of second refractive member 1220 is a plurality, a plurality of second refractive members 1220 are sequentially arranged in the direction from the input end 1101 to the output end 1102.

The disclosure provides an example of a method for manufacturing a cladding light stripper. In the method, when connecting a pump tube and a beam combiner, coating layers on two ends of a pump optical fiber (a pump source) and coating layers on two ends of a coupling optical fiber are removed simultaneously in a length of 2.3 cm to 2.5 cm in a direction from an output end of the optical fiber to an output end of the device, and then an output pigtail of the pump tube is welded to the coupling optical fiber.

The welded bare optical fiber is fixed on the installation position with a cold water channel at the bottom to cool it down.

A small injection needle tube is used to apply a glue with a low refractive index at the welding position in the circumferential direction by a spot coating process, and an applying length of the glue in the extension direction of the optical fiber is 0.3 cm to 0.5 cm, and then the glue is cured by ultraviolet radiation. Due to the welding loss at the welding position, the glue with a low refractive index can protect and encapsulate the optical fiber. At the welding point, there will be light leakage itself. If the glue with a high refractive index is applied, the total reflection condition of light will be destroyed, and the temperature there will be too high.

A glue with a high refractive index is applied at the edge of a glue with a low refractive index of the pump optical fiber in the circumferential direction, and then the glue is pulled outward by using an optical fiber rod tool. The amount of the glue gradually decreases along the stretching direction, and then the glue is cured.

A glue with a high refractive index is also applied at the edge of a stripping opening of the coupler optical fiber, and then the glue is pulled towards the middle of the welding position by using an optical fiber rod tool, causing the amount of the glue decreases in a gradient, and then the glue is cured.

It was found from experiments that this method can replace the stripper for a pump tube with cladding light less than 15 W. In addition, for a laser apparatus composed of multiple pump tubes, the method can reduce the cost and simply the manufacturing process.

Some embodiments of the disclosure further provide a laser apparatus including the cladding light stripper 1000 as described above, and the structure of the cladding light stripper 1000 can refer to any one of the above embodiments. Since the cladding light stripper 1000 of the laser apparatus adopts all the technical solutions of all the above embodiments, it has at least all the beneficial effects brought by the technical solutions of the above embodiments, and will not be repeated herein.

In the above laser apparatus, cladding light in the optical fiber 1100 of the laser apparatus can be safely stripped by using the above-mentioned cladding light stripper 1000. For example, for the laser apparatus composed of multiple pump tubes, since a plurality of optical fibers 1100 are connected to each other, the cost can be reduced by using the cladding light stripper 1000.

In the above-described embodiments, the description of each embodiment has its own emphasis. For parts not described in detail in a certain embodiment, please refer to relevant description of other embodiments.

The above provides a detailed introduction to the cladding light stripper, the method for manufacturing the cladding light stripper, and the laser apparatus provided in the embodiments of the disclosure. Specific embodiments are applied in this context to explain the principles and implementation methods of the disclosure. The explanation of the above-mentioned embodiments is only used to help understand the technical solutions and fiber core ideas of the disclosure. For ordinary skilled in the art, there may be changes in the specific implementation methods and application scopes based on the ideas of the disclosure. Therefore, the contents of the disclosure should not be understood as limitations on the disclosure.

What is claimed is:

1. A cladding light stripper comprising:
an optical fiber comprising a fiber core and a cladding layer covering the fiber core; and
a refractive component comprising at least one first refractive member, wherein the first refractive member covers at least a part of an outer peripheral surface of the cladding layer, a refractive index of the first refractive member is greater than a refractive index of the cladding layer, and cross-sectional areas of the first refractive member in a radial direction of the optical fiber gradually increase in a direction from an input end to an output end of the optical fiber.

2. The cladding light stripper of claim 1, wherein thicknesses of the first refractive member in a radial direction of the fiber core gradually increase in the direction from the input end to the output end.

3. The cladding light stripper of claim 2, wherein the refractive component comprises a plurality of first refractive members sequentially arranged in the direction from the input end to the output end.

4. The cladding light stripper of claim 1, wherein the fiber core comprises a first sub-fiber core and a second sub-fiber core sequentially connected from the input end to the output end, the cladding layer comprises a first sub-cladding layer and a second sub-cladding layer sequentially connected from the input end to the output end, the first sub-cladding layer covers the first sub-fiber core, and the second sub-cladding layer covers the second sub-fiber core; and the first refractive member covers at least a part of an outer peripheral surface of the first sub-cladding layer; and
wherein the cladding light stripper further comprises a reflective member covering the outer peripheral surface of the cladding layer at a connection of the first sub-cladding layer and the second sub-cladding layer, and a refractive index of the reflective member is less than the refractive index of the cladding layer.

5. The cladding light stripper of claim 4, wherein the refractive component further comprises at least one second refractive member covering the outer peripheral surface of the cladding layer, a refractive index of the second refractive member is greater than the refractive index of the cladding layer, and the second refractive member is disposed at a side of the reflective member in the direction from the input end to the output end.

6. The cladding light stripper of claim 5, wherein cross-sectional areas of the second refractive member in the radial direction of the optical fiber gradually increase in the direction from the input end to the output end; and
the refractive component comprises a plurality of second refractive members sequentially arranged in the direction from the input end to the output end.

7. The cladding light stripper of claim 5, wherein the optical fiber further comprises a first coating layer and a second coating layer covering the cladding layer, the first coating layer and the second coating layer are sequentially arranged at intervals in the direction from the input end to the output end, and the refractive component is disposed between the first coating layer and the second coating layer; and
a ratio of a length of the refractive component in an extension direction of the optical fiber to a distance between the first coating layer and the second coating layer is greater than or equal to 90%; and a ratio of a total length of the first refractive member in the extension direction of the optical fiber to the distance between the first coating layer and the second coating layer is greater than or equal to 46%.

8. A method for manufacturing a cladding light stripper comprising the steps of:
providing an optical fiber, wherein the optical fiber comprises a fiber core and a cladding layer covering the fiber core; and
disposing at least one first refractive member on an outer peripheral surface of the cladding layer, wherein the first refractive member covers at least a part of the outer peripheral surface of the cladding layer, a refractive index of the first refractive member is greater than a refractive index of the cladding layer, and cross-sectional areas of the first refractive member in a radial direction of the optical fiber gradually increase in a direction from an input end to an output end of the optical fiber.

9. The method of claim 8, wherein a step of disposing the first refractive member on an outer peripheral surface of the cladding layer comprises:
applying a refractive glue on the outer peripheral surface of the cladding layer, wherein a refractive index of the refractive glue is greater than the refractive index of the cladding layer; and
stretching the refractive glue in the direction from the output end to the input end of the optical fiber by using a stretching member to form the first refractive member.

10. The method of claim 8, wherein the first refractive member is plural, and a plurality of first refractive members are sequentially arranged in the direction from the input end to the output end.

11. The method of claim 8, wherein the optical fiber comprises a first sub-fiber core and a second sub-fiber core sequentially connected from the input end to the output end, the cladding layer comprises a first sub-cladding layer and a second sub-cladding layer sequentially connected from the input end to the output end, the first sub-cladding layer covers the first sub-fiber core, and the second sub-cladding layer covers the second sub-fiber core; and the first refractive member covers at least a part of an outer peripheral surface of the first sub-cladding layer; and
wherein the method further comprises:
disposing a reflective member on an outer peripheral surface at a connection of the first sub-cladding layer and the second sub-cladding layer, wherein the reflective member covers the cladding layer, and a refractive index of the reflective member is less than the refractive index of the cladding layer.

12. The method of claim 11, further comprising: disposing a second refractive member covering the outer peripheral surface of the cladding layer at a side of the reflective member in the direction from the input end to the output end, wherein a refractive index of the second refractive member is greater than the refractive index of the cladding layer.

13. The method of claim 12, wherein cross-sectional areas of the second refractive member in the radial direction of the optical fiber gradually increase in the direction from the input end to the output end; or, cross-sectional areas of the second refractive member in the radial direction of the optical fiber remain constant in the direction from the input end to the output end.

14. A laser apparatus comprising a cladding light stripper, wherein the cladding light stripper comprises:
an optical fiber comprising a fiber core and a cladding layer covering the fiber core; and
a refractive component comprising at least one first refractive member, wherein the first refractive member covers at least a part of an outer peripheral surface of the cladding layer, a refractive index of the first refractive member is greater than a refractive index of the cladding layer, and cross-sectional areas of the first refractive member in a radial direction of the optical fiber gradually increase in a direction from an input end to an output end of the optical fiber.

15. The laser apparatus of claim 14, wherein thicknesses of the first refractive member in a radial direction of the fiber core gradually increase in the direction from the input end to the output end.

16. The laser apparatus of claim 15, wherein the refractive component comprises a plurality of first refractive members sequentially arranged in the direction from the input end to the output end.

17. The laser apparatus of claim 14, wherein the fiber core comprises a first sub-fiber core and a second sub-fiber core sequentially connected from the input end to the output end, the cladding layer comprises a first sub-cladding layer and a second sub-cladding layer sequentially connected from the input end to the output end, the first sub-cladding layer covers the first sub-fiber core, and the second sub-cladding layer covers the second sub-fiber core; and the first refractive member covers at least a part of an outer peripheral surface of the first sub-cladding layer; and
wherein the cladding light stripper further comprises a reflective member covering the outer peripheral surface of the cladding layer at a connection of the first sub-cladding layer and the second sub-cladding layer, and a refractive index of the reflective member is less than the refractive index of the cladding layer.

18. The laser apparatus of claim 17, wherein the refractive component further comprises at least one second refractive member covering the outer peripheral surface of the cladding layer, a refractive index of the second refractive member is greater than the refractive index of the cladding layer, and the second refractive member is disposed at a side of the reflective member in the direction from the input end to the output end.

19. The laser apparatus of claim 18, wherein cross-sectional areas of the second refractive member in the radial direction of the optical fiber gradually increase in the direction from the input end to the output end; and
the refractive component comprises a plurality of second refractive members sequentially arranged in the direction from the input end to the output end.

20. The laser apparatus of claim 18, wherein the optical fiber further comprises a first coating layer and a second coating layer covering the cladding layer, the first coating layer and the second coating layer are sequentially arranged at intervals in the direction from the input end to the output end, and the refractive component is disposed between the first coating layer and the second coating layer; and
a ratio of a length of the refractive component in an extension direction of the optical fiber to a distance between the first coating layer and the second coating layer is greater than or equal to 90%; and a ratio of a total length of the first refractive member in the extension direction of the optical fiber to the distance between the first coating layer and the second coating layer is greater than or equal to 46%.
